(19) United States
(12) Patent Application Publication
(10) Pub. No.: US 2017/0226380 A1
(43) Pub. Date: Aug. 10, 2017

(54) POLISHING SOLUTIONS AND METHODS OF USING SAME

(71) Applicant: 3M INNOVATIVE PROPERTIES COMPANY, St. Paul, MN (US)

(72) Inventors: John J. Gagliardi, Hudson, WI (US); Eric C. Coad, Woodbury, MN (US); Evan L. Schwartz, Vadnais Heights, MN (US)

(21) Appl. No.: 15/329,374

(22) PCT Filed: Jul. 31, 2015
(86) PCT No.: PCT/US2015/043035

§ 371 Date: Jan. 26, 2017

Related U.S. Application Data
(60) Provisional application No. 62/032,051, filed on Aug. 1, 2014.

(51) Int. Cl. C09G 1/02; B24B 37/26; B24B 37/04; B24B 37/24; C09K 3/14; C01F 7/02

(52) U.S. Cl. CPC C09G 1/02; C09K 3/1409; C01F 7/02; B24B 37/044; B24B 37/245; B24B 37/26

(57) ABSTRACT

A polishing solution includes a fluid component and a plurality of conditioning particles. The fluid component includes water, a basic pH adjusting agent, and a polymeric thickening agent. The polymeric thickening agent is present in the fluid component at greater than 0.01 weight percent based on the total weight of the polishing solution.

### FIELD

The present disclosure relates to polishing solutions useful for the polishing of substrates, and methods of using such polishing solutions.

### BACKGROUND

Various compositions, systems, and methods have been introduced for the polishing of sapphire. Such compositions, systems, and methods are described, for example, in Li Z. C., Pei Z. J., Funkenbusch P. D., 2011, Machining processes for sapphire wafers: a literature review, Proceedings of the Institution of Mechanical Engineers 225 Part B, 975-989.

### SUMMARY

In some embodiments, a polishing solution is provided. The polishing solution includes a fluid component. The fluid component includes water, a basic pH adjusting agent, and a polymeric thickening agent. The polymeric thickening agent is present in the fluid component at greater than 0.01 weight percent based on the total weight of the polishing solution. The polishing solution further includes a plurality of conditioning particles, which are dispersed in the fluid component.

In some embodiments, a method of polishing a substrate is provided. The method includes providing a polishing pad, providing a substrate having a major surface to be polished, and contacting said major surface with the polishing pad and the polishing solution while there is relative motion between the polishing pad and the substrate.

The above summary of the present disclosure is not intended to describe each embodiment of the present disclosure. The details of one or more embodiments of the disclosure are also set forth in the description below. Other features, objects, and advantages of the disclosure will be apparent from the description and from the claims.

### BRIEF DESCRIPTION OF THE DRAWINGS

The disclosure may be more completely understood in consideration of the following detailed description of various embodiments of the disclosure in connection with the accompanying figures, in which:

FIG. 1 illustrates a schematic of an example of a polishing system for utilizing the polishing solutions and methods of some embodiments of the present disclosure.

### DETAILED DESCRIPTION

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Currently, ultrahard substrate (e.g., sapphire substrates) finishing processes are fixed abrasive processes or abrasive processes that involve the use of abrasive charged metal plates followed by chemical mechanical polishing with colloidal silica slurry. The challenges of lapping and polishing ultrahard substrates have not been satisfied using known versions of such processes. For example, inadequate material removal rates, poor surface finish, sub surface damage, high cost, and overall process difficulty have all been associated with such known processes.

The present disclosure is directed to compositions, systems, and methods useful for polishing substrates that overcomes many of the aforementioned problems associated with conventional abrasive processes.

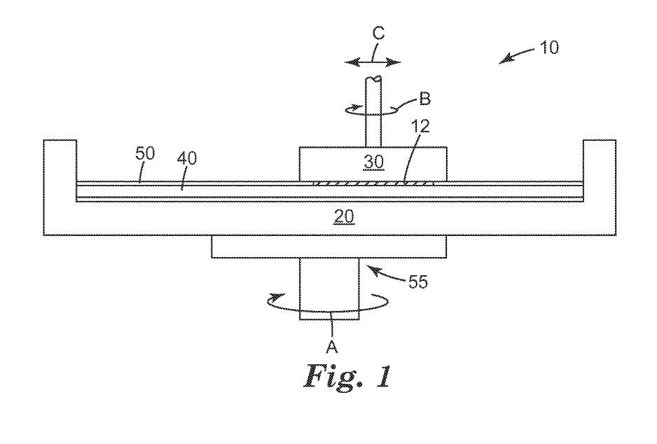

FIG. 1 schematically illustrates an example of a polishing system 10 for utilizing articles and methods in accordance with some embodiments of the present disclosure. As shown, the system 10 may include a platen 20, a carrier assembly 30, a polishing pad 40, and a layer of a polishing solution 50 disposed about a major surface of the polishing pad 40. During operation of the polishing system 10, a drive assembly 55 may rotate (arrow A) the platen 20 to move the polishing pad 40 to carry out a polishing operation. The polishing pad 40 and the polishing solution 50 may separately, or in combination, define a polishing environment that mechanically and/or chemically removes material from or polishes a major surface of a substrate 12. To polish the major surface of the substrate 12 with the polishing system 10, the carrier assembly 30 may press the substrate 12 against a polishing surface 42 of the polishing pad 40 in the presence of the polishing solution 50. The platen 20 (and thus the polishing pad 40) and/or the carrier assembly 30 then move relative to one another to translate the substrate 12 across the polishing surface 42 of the polishing pad 40. The carrier assembly 30 may rotate (arrow B) and optionally transverse laterally (arrow C). As a result, the abrasive particles (which may be contained in the polishing pad 40 and/or the polishing solution 50) and/or the chemicals in the polishing environment remove material from the surface of the substrate 12. It is to be appreciated that the polishing system 10 of FIG. 1 is only one example of a polishing system that may be employed in connection with the articles and methods of the present disclosure, and that other conventional polishing systems may be employed without deviating from the scope of the present disclosure.

In some embodiments, the polishing solutions 50 of the present disclosure may include a fluid component having conditioning particles dispersed and/or suspended therein. The fluid component may be aqueous, and include a basic pH adjusting agent and a polymeric thickening agent.

In various embodiments, the fluid component may be aqueous. As used herein, an aqueous fluid is defined as a fluid that is at least 40% by weight water. The fluid component may contain at least 50 wt. %, at least 60 wt. %, at least 70 wt. %, at least 80 wt. %, at least 90 wt. %, or at least 95 wt. % water, based on the total weight of the polishing solution. The fluid component may further include one or more non-aqueous components such as alcohols; e.g. ethanol, propanol, isopropanol, butanol, ethylene glycol, propylene glycol, glycerol, polyethylene glycol, triethylene glycol; acetates, e.g. ethyl acetate, butyl acetate; ketones, e.g. methyl ethyl ketone, organic acids, e.g., acetic acid; ethers; triethanolamine; complexes of triethanolamine such as silitrane or boron equivalents; glycols; glycol ethers; or combinations thereof. The fluid component may include at least 1 wt. %, at least 5 wt. %, at least 10 wt. %, at least 25 wt. %, or at least 40 wt. % non-aqueous components, based on the total weight of the polishing solution. When the fluid component includes both aqueous and non-aqueous fluids, the resulting fluid component may be homogeneous, i.e. a single phase solution.

In illustrative embodiments, the basic pH adjusting agent may be any material (or combination of materials) that forms a basic solution in water. In this regard, the basic pH adjusting agent of the fluid component may facilitate the pH adjustment and/or stabilization of a polishing solution such that it has a pH of between 8-14, 8-12, or 8-11. In some embodiments, the pH adjusting agent may be a salt of boric acid. For example, suitable salts of boric acid may include derivatives of sodium borate, such as sodium tetraborate (also known as “Borax”), sodium tetraborate decahydrate, disodium tetraborate, borax pentahydrate, and borax decahydrate. The basic pH adjusting agents may include other compounds, such as organic and inorganic bases. Suitable examples of organic and inorganic bases include calcium hydroxide, potassium hydroxide, tetramethylammonium hydroxide, sodium hydroxide, lithium hydroxide, cesium hydroxide, and magnesium hydroxide. The basic pH adjusting agent may be present in the fluid component in an amount of at least 0.1 wt. %, at least 0.5 wt. %, at least 1 wt. %, at least 5 wt. %, or at least 10 wt. % based on the based on the total weight of the polishing solution.

In some embodiments, the polymeric thickening agent may be any material useful for increasing the viscosity of the fluid component. The polymeric thickening agent may be water soluble. For example, suitable polymeric thickening agents may include polyethylene oxide, polyvinylpyrrolidone, polyethyleneimine, cellulose derivatives (hydroxypropylmethyl cellulose, hydroxyethyl cellulose, cellulose acetate butyrate, etc.) polyvinyl alcohol, poly(meth)acrylic acid, polyethylene glycol, poly(meth)acrylamide, polystyrene sulfonate, or any combinations thereof. The polymeric thickening agent may be present in the fluid component in an amount of at least 0.01 wt. %, at least 0.05 wt. %, at least 0.5 wt. %, at least 1 wt. %, at least 5 wt. %, at least 10 wt. %, or at least 25 wt. %, based on the total weight of the polishing solution.

In some embodiments, the fluid component may further include one or more additives such as, for example, dispersion aids, corrosion inhibitors, surfactants, chelating agents/complexing agents, passivating agents, foam inhibitor, and combinations thereof.

In illustrative embodiments, the materials that comprise the fluid component may be selected such that the conditioning particles are insoluble, but well dispersed in the fluid component.

Generally, the conditioning particles may be intended to condition or abrade a component of a polishing pad that is intended for polishing a substrate (e.g., a resin material having abrasive particles embedded therein), but provide minimal or no appreciable abrading or grinding of the substrate to be polished. In this regard, in some embodiments, the conditioning particles of the present disclosure may include conditioning particles having a hardness, e.g. Mohs hardness, less than the hardness of the substrate to be polished (e.g., sapphire) and/or a hardness greater than or about the same as the hardness of the abrasive particles of a polishing pad that is intended for polishing the substrate. In some embodiments, the conditioning particles of the present disclosure may have a Mohs hardness value of between 5.5 and 9.7 or between 6.0 and 9.0. In some embodiments, the conditioning particles may include alumina, diamond, cubic boron nitride, silicon carbide, boron carbide, alumina zirconia, corundum, iron oxide, ceria, garnet, glass, and combinations thereof. In one embodiment, the conditioning particles may consist essentially of any one of the foregoing materials. In some embodiments, the conditioning particles may have an average size (average major axial diameter or longest straight line between two points on a composite) of between 1 and 20 μm, between 1 and 10 μm, or between 1 and 3 μm. In some embodiments, the conditioning particles may have an average size close to, or lower than, the size of the abrasive particles of the polishing pad to be used in conjunction with the polishing solution, for example, an average size of 125%, 100%, 75%, or even less, as compared to the average size of the abrasive particles of the polishing pad.

In various embodiments, the conditioning particles may be present in the fluid component in an amount of at least 0.5 wt. %, at least 2.5 wt. %, or at least 5 wt. % based on the based on the total weight of the polishing solution.

The present disclosure further relates to methods of polishing substrates using the above-described polishing solutions. The methods may be carried out using a polishing system such as that described with respect to FIG. 1, or with any other conventional polishing system, e.g. single or double sided polishing and lapping. In some embodiments, a method of polishing substrate may include providing a substrate to be polished. The substrate may be any substrate for which polishing and/or planarization is desirable. For example, the substrate may be a metal, metal alloy, metal oxide, ceramic, or polymer (commonly in the form of a semiconductor wafer or optical lens). In some embodiments, the methods of the present disclosure may be particularly useful for polishing ultrahard substrates such as sapphire (A, R, or C planes), silicon, silicon carbide, quartz, or silicate glasses. The substrate may have one or more surfaces to be polished.

In various embodiments, the method may further include providing a polishing pad and a polishing solution. The polishing solution may be the same as or similar to the above-described polishing solutions.

In some embodiments, the polishing pad may be a fixed-abrasive polishing pad. As used herein, a fix-abrasive polishing pad refers to a chemical mechanical polishing, or planarization pad which has plurality of abrasive particles or components embedded therein, or otherwise attached thereto. The fixed abrasive pad may be two-dimensional, i.e. a convention abrasive sheet with a layer of abrasive particles held to a backing by one or more resin or binder layers, or it may be a three-dimensional fixed abrasive, i.e. a resin or binder layer that contains abrasive particles dispersed therein, forming a resin/abrasive composite which has appropriate height to allow for the resin/abrasive composite to wear during use and/or dressing to expose a fresh layer of abrasive particles. The abrasive article may comprise a three-dimensional, textured, flexible, fixed abrasive construction having a first surface and a working surface. The working surface may comprise a plurality of precisely shaped abrasive composites. The precisely shaped abrasive composite may comprise a resin phase and an abrasive phase.

The precisely shaped abrasive composites may be arranged in an array to form the three-dimensional, textured, flexible, fixed abrasive construction. Suitable arrays include, for instance, those described in U.S. Pat. No. 5,958,794 (Bruxvoort et al.). The abrasive article may comprise abrasive constructions that are patterned, Abrasive articles available under the trade designation TRIZACT abrasive and TRIZACT diamond tile abrasives available from 3M Company, St. Paul, Minn., are exemplary patterned abrasives. Patterned abrasive articles include monolithic rows of abrasive composites precisely aligned and manufactured from a die, mold, or other techniques. Such patterned abrasive articles can abrade, polish, or simultaneously abrade and polish.

The abrasive article may include a three-dimensional, textured, flexible, fixed abrasive construction having a first surface and a working surface. In some embodiments, the first surface may further be in contact with a backing, optionally with an adhesive interposed therebetween. Any variety of backing materials are contemplated, including both flexible backings and backings that are more rigid. Examples of flexible backings include, for instance, polymeric film, primed polymeric film, metal foil, cloth, paper, vulcanized fiber, nonwovens and treated versions thereof and combinations thereof. Examples include polymeric films of polyester, and co-polyester, micro-voided polyester, polyimide, polycarbonate, polyamide, polyvinyl alcohol, polypropylene, polyethylene, and the like. When used as a backing, the thickness of a polymeric film backing is chosen such that a desired range of flexibility is retained in the abrasive article.

The shape of each precisely shaped abrasive composite may be selected for the particular application (e.g., workpiece material, working surface shape, contact surface shape, temperature, resin phase material). The shape of each precisely shaped abrasive composite may be any useful shape, e.g., cubic, cylindrical, prismatic, right parallelepiped, pyramidal, truncated pyramidal, conical, hemispherical, truncated conical, cross, or post-like sections with a distal end. Composite pyramids may, for instance, have three, four sides, five sides, or six sides. The cross-sectional shape of the abrasive composite at the base may differ from the cross-sectional shape at the distal end. The transition between these shapes may be smooth and continuous or may occur in discrete steps. The precisely shaped abrasive composites may also have a mixture of different shapes. The precisely shaped abrasive composites may be arranged in rows, spiral, helix, or lattice fashion, or may be randomly placed. The precisely shaped abrasive composites may be arranged in a design meant to guide fluid flow and/or facilitate swarf removal.

The lateral sides forming the precisely shaped abrasive composite may be tapered with diminishing width toward the distal end. The tapered angle may be from about 1 to less than 90 degrees, for instance, from about 1 to about 75 degrees, from about 3 to about 35 degrees, or from about 5 to about 15 degrees. The height of each precisely shaped abrasive composite is preferably the same, but it is possible to have precisely shaped abrasive composites of varying heights in a single article.

The base of the precisely shaped abrasive composites may abut one another or, alternatively, the bases of adjacent precisely shaped abrasive composites may be separated from one another by some specified distance. In some embodiments, the physical contact between adjacent abrasive composites involves no more than 33% of the vertical height dimension of each contacting precisely shaped abrasive composite. This definition of abutting also includes an arrangement where adjacent precisely shaped abrasive composites share a common land or bridge-like structure which contacts and extends between facing lateral surfaces of the precisely shaped abrasive composites. The abrasives are adjacent in the sense that no intervening composite is located on a direct imaginary line drawn between the centers of the precisely shaped abrasive composites.

The precisely shaped abrasive composites may be set out in a predetermined pattern or at a predetermined location within the abrasive article. For example, when the abrasive article is made by providing an abrasive/resin slurry between a backing and mold, the predetermined pattern of the precisely shaped abrasive composites will correspond to the pattern of the mold. The pattern is thus reproducible from abrasive article to abrasive article.

The predetermined patterns may be in an array or arrangement, by which is meant that the composites are in a designed array such as aligned rows and columns, or alternating offset rows and columns. In another embodiment, the abrasive composites may be set out in a “random” array or pattern. By this is meant that the composites are not in a regular array of rows and columns as described above. It is understood, however, that this “random” array is a predetermined pattern in that the location of the precisely shaped abrasive composites is predetermined and corresponds to the mold.

In some embodiments, the resin phase may include a cured or curable organic material. The method of curing is not critical, and may include, for instance, curing via energy such as UV light or heat, Examples of suitable resin phase materials include, for instance, amino resins, alkylated urea-formaldehyde resins, melamine-formaldehyde resins, and alkylated benzoguanamine-formaldehyde resins. Other resin phase materials include, for instance, acrylate resins (including acrylates and methacrylates), phenolic resins, urethane resins, and epoxy resins. Particular acrylate resins include, for instance, vinyl acrylates, acrylated epoxies, acrylated urethanes, acrylated oils, and acrylated silicones. Particular phenolic resins include, for instance, resole and novolac resins, and phenolic/latex resins. The resins may further contain conventional fillers and curing agents such as are described, for instance, in U.S. Pat. No. 5,958,794 (Bruxvoort et al incorporated herein by reference.

Examples of suitable abrasive particles for the fixed abrasive pad include fused aluminum oxide, heat treated aluminum oxide, white fused aluminum oxide, black silicon carbide, green silicon carbide, titanium diboride, boron carbide, silicon nitride, tungsten carbide, titanium carbide, diamond, cubic boron nitride, hexagonal boron nitride, garnet, fused alumina zirconia, alumina-based sol gel derived abrasive particles and the like. The alumina abrasive particle may contain a metal oxide modifier. Examples of alumina-based sol gel derived abrasive particles can be found in U.S. Pat. Nos. 4,314,827; 4,623,364; 4,744,802; 4,770,671; and 4,881,951, all incorporated herein by reference. The diamond and cubic boron nitride abrasive particles may be mono crystalline or polycrystalline. Other examples of suitable inorganic abrasive particles include silica, iron oxide, chromia, ceria, zirconia, titania, tin oxide, gamma alumina, and the like.

In various embodiments, the polishing pads of the present disclosure may be manufactured in accordance with the disclosure of U.S. Pat. Nos. 5,910,471 and 6,231,629, which are incorporated by reference herein in their entirety.

In some embodiments, the polishing pads of the present disclosure may include one or more additional layers. For example, the polishing pad may include adhesive layers such as pressure sensitive adhesives, hot melt adhesives, or epoxies. “Sub pads” such as thermoplastic layers, e.g. polycarbonate layers, which may impart greater stiffness to the pad, may be used for global planarity. Sub pads may also include compressible material layers, e.g. foamed material layers. Sub pads which include combinations of both thermoplastic and compressible material layers may also be used. Additionally, or alternatively, metallic films for static elimination or sensor signal monitoring, optically clear layers for light transmission, foam layers for finer finish of the workpiece, or ribbed materials for imparting a “hard band” or stiff region to the polishing surface may be included.

In some embodiments, the method may further include contacting a surface of the substrate with the polishing pad and the polishing solution while there is relative motion between the polishing pad and the substrate. For example, referring again to the polishing system of FIG. 1, the carrier assembly 30 may apply pressure to the substrate 12 against a polishing surface of the polishing pad 40 in the presence of the polishing solution 50 as the platen 20 is moved (e.g., translated and/or rotated) relative to the carrier assembly 30. Additionally, the carrier assembly 30 may be moved (e.g., translated and/or rotated) relative to the platen 20. Continued pressure and relative motion between the substrate and the polishing surface may then result in polishing of the substrate.

In illustrative embodiments, the systems and methods of the present disclosure are particularly suited for the finishing of ultra hard substrates such as sapphire, A, R, or C planes. Finished sapphire crystals, sheets or wafers are useful, for example, in the light emitting diode industry and cover layer for mobile hand held devices. In such applications, the systems and methods provide persistent removal of material.

As will be appreciated by those skilled in the art, the polishing pads of the present disclosure can be formed according to a variety of methods including, e.g., molding, extruding, embossing and combinations thereof.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

### Materials

Materials

| Abbreviation or | |
|---|---|
| Trade Name | Description |
| A174 | 3-methacryloxypropyltrimethoxysilane, available as |
| | SILQUEST A-174 from Momentive Performance |
| | Materials, Albany, New York |
| CH543HT | lubricant, available as CHALLENGE 543HT from |
| | Intersurface Dynamics, Inc., Bethel, Connecticut |
| GF | alumina-borosilicate glass frit having a composition of |
| | 63.6% SiO₂, 18% B₂O₃, 8.5% Al₂O₃, 2.8% BaO, 1.1% |
| | CaO, 2.1% Na₂O, 2.9% K₂O, 1.0% Li₂O, and having a |
| | median particle size (by light scattering) of about |
| | 10.6 microns, available as SP 1086 from Specialty |
| | Glass, Inc., Oldsmar, Florida |
| Hy-AlOx | hydrated aluminum oxide, available as BOEHMITE from |
| | Sasol North America, Houston, Texas |
| IRG819 | bis(2,4,6-trimethylbenzoyl)phenylphosphine oxide, |
| | available as IRGACURE 819 from the BASF Corpora- |
| | tion, Florham Park, New Jersey |
| MCD-1 | 4-8 micron monocrystalline diamond, available as RJK-1 |
| | from Diamond Innovations Worthington, Ohio. |
| NaB Soln | A saturated solution of sodium borate in de-ionized |
| | water, approximately 26 g sodium borate per liter of |
| | water. |
| NaOH-2M | A 2M sodium hydroxide solution prepared from sodium |
| | hydroxide and de-ionized water. |
| OX50 | fumed silica, available as AEROSIL OX50 from Evonik |
| | Industries, Parsippany, New Jersey |
| PolyOx | Polyethylene oxide, Mw~1,000,000 g/mol available as |
| | POLYOX WSR-N12K from Dow Chemical Company, |
| | Midland, Michigan |
| PWA-3 | 3 micron plated white alumina, available as PWA 3 from |
| | Fujimi, Inc., Kiyosu, Japan |
| PWA-5 | 5 micron plated white alumina, available under as PWA |
| | 5 from Fujimi, Inc |
| SP32000 | polymeric dispersant, available as SOLSPERSE 32000 |
| | from Lubrizol, Ltd., Manchester, United Kingdom |
| SR368D | tris(2-hydroxyethyl) isocyanurate triacrylate, available as |
| | SR368D from Sartomer USA, LLC, Exton, Pennsylvania |
| Standex 230 | dextrin, available as STANDEX 230 from A. E. Staley |
| | Manufacturing Company, Decatur, Illinois |
| VAZO 52 | 2,2′-azobis(2,4-dimethylpentanenitrile), available as |
| | VAZO 52 from E. I. du Pont de Nemours and Co., |
| | Wilmington, Delaware |
| W400 | surface treated calcium metasilicate filler, available as |
| | WOLLASTOCOAT 400 from NYCO, Willsboro, |
| | NewYork |

### Test Methods and Preparation Procedures

### Polishing Test 1

Polishing was conducted using a CETR-CP-4 bench top polisher, available from Bruker Corporation, Billerica, Mass. Polishing pressure was varied, being 3 psi or 6 psi, see Table 1a and Table 1b, respectively. A 9 inch (22.9 cm) diameter pad with a 0.7 inch (1.8 cm) center hole was mounted to the platen of the polisher using a double sided adhesive tape. The pad was a 3M TRIZACT DIAMOND TILE 677XA, 6.0 Micron, available from 3M Company, St. Paul, Minn. The platen was rotated at 120 rpm. A bronze carrier, having three recesses, each with a diameter of about 4.5 inches (11.4 cm), was mounted to the upper drive shaft of the CP-4. The head of the polisher was rotated at 121 rpm. The upper drive shaft slider was adjusted to sweep from 43-55 mm. Three, sapphire wafers (A-plane, R-plane or C-plane), 5.1 cm diameter×0.5 cm thick, were mounted in the carrier recesses and polished. The diameter of the carrier holes was slightly larger than the diameter of the sapphire wafers, allowing the wafers to rotate freely in the carrier holes. Polishing time was 30 minutes. Lubricant, at two different flow rates, was added to the pad surface at two locations, 3 ml/min at the inside diameter of the pad and 7 ml/min at 4.5 inches (11.4 cm) from the pad center. Lubricant types are listed in Table 1. Wafers were measured gravimetrically before and after polishing. Two sets of three wafers were polished in this manner and used to calculate average removal rate and measure surface roughness (Table 1). The test was repeated for each of the three sapphire wafer types. The measured weight loss was used to determine the amount of material removed, based on a wafer density of 3.97 g/cm³. Removal rate, reported in microns/minute, is the average thickness reduction of the second set of three wafers over the 30 minute polishing interval. It is noted that, during the first 10 minutes of any given polishing experiment, the surface texture of the wafer might have had a roughness unrelated to the surface roughness developed on the wafer surface through the polishing process. The pad was washed thoroughly with deionized water after every 30 minute polishing interval and prior to the start of testing of a new lubricant.

### Polishing Test 2

Polishing was conducted using a AC500 double sided polishing tool available from Peter Wolters Gmbh, Rendsberg, Germany. Polishing pressure was 3 psi. The pad was Pad-1, described below. A sheet of double sided pressure sensitive adhesive tape, available as 3M DOUBLE COATED TAPE 442PC from 3M Company St. Paul, Minn., was then laminated to the side of a structured abrasive pad opposite the features. A subpad, a 50 mil (0.13 mm) thick polycarbonate sheet, was laminated to the structured abrasive pad via the 442PC tape. An 18.25 inch (46.4 cm) diameter pad with a 7 inch (17.8 cm) center hole was mounted to the platen of the polisher using a double sided adhesive tape. The bottom and the top platen were rotated at 60 rpm in opposite directions, clockwise and counter-clockwise, respectively. Five brass carriers having three 2 inch (5.1 cm) diameter holes in each to hold the 2 inch (5.1 cm) sapphire parts. Six A-Plane sapphire wafers, 5.1 cm diameter×0.5 cm thick, were positioned in the carrier holes.

The polishing time was 30 minutes. The lubricant was added at a flow rate of 35 ml/min to the pad surface at a location near the pad center. Lubricant types are listed in Table 2. Three of the six wafers were measured gravimetrically before and after polishing. The measured weight loss of the three wafers was used to determine the amount of material removed, based on a wafer density of 3.97 g/cm³. The removal rate, reported in microns/minute, is the average thickness reduction of three wafers over the 30 minute polishing interval. It is noted that, during the first 10 minutes of any given polishing experiment, the surface texture of the wafer might have had a roughness unrelated to the surface roughness developed on the wafer surface through the polishing process. The pad was washed thoroughly after every 30 minute polishing interval and prior to the start of testing of a new lubricant.

### Surface Finish Test

After polishing, sapphire wafers were rinsed with deionized water and dried. Surface roughness measurements, including Ra, Rz and Rmax, were measured using a MAHR—PERTHOMETER model M4P available from University of North Carolina, Charlotte, N.C. The stylus travel was set at 1.5 cm and the scan rate was 0.5 mm/sec.

### Pad Wear Test

Pad thickness, before and after polishing was measured using a digital caliper, available from Mitutoyo America Corporation, Aurora, Ill. The pad wear rate was calculated from the thickness difference, before and after a polishing test, divided by the test time.

### G-Ratio Calculation

The G-Ratio is the ratio of the polishing rate of the substrate (sapphire wafer) in microns/min divided by the pad wear rate in microns/min, giving a unit-less number.

### Preparation of Pad-1

Abrasive agglomerates were prepared following the general procedures disclosed in U.S. Pat. No. 6,551,366 (D'Souza, et al.).

A spray dried agglomerate was prepared from an aqueous dispersion, using a spray drying technique, as follows. Standex 230, 1.8 grams, was dissolved in about 40.0 grams of de-ionized water by stirring using an air mixer with a Cowles blade. Next, about 23.3 grams of milled GF was added to the solution. The GF had been milled prior to use to a median particle size of about 2.5 micrometers. About 34.9 grams of MCD-1 diamond was added to the solution, yielding a diamond/glass frit ratio of about 60:40 (wt./wt.). The solution was stirred using the air mixer for an additional 30 minutes after all the above constituents had been added together.

The solution was then atomized in a centrifugal atomizer, a MOBILE MINER 2000 from GEA Process Engineering A/S, Soborg, Denmark. The atomization wheel was running at 20000 rpm. The slurry was pumped into the rotary wheel inlet at a pump speed flow rate setting of 4. Air was supplied at 150° C. into the atomization chamber and was used to dry the droplets as they formed, producing spray dried, precursor abrasive agglomerates. The outlet temperature of the spray dryer varied from 90-95° C.

The precursor abrasive agglomerates were then vitrified by mixing with 40% by weight PWA-3, placing the precursor agglomerate/PWA-3 powder mixture in a refractor sager (available from Ipsen Ceramics of Ipsen Inc., Pecatonica, Ill.) and heating in a furnace in air, forming abrasive agglomerates. The PWA-3 is used as a parting agent to prevent the precursor abrasive agglomerate particles from aggregating together during the vitrifying process. The heating schedule for the vitrifying process was as follows: a 2° C./min temperature ramp to 400° C., a 1 hour anneal at 400° C., a 2° C./min temperature ramp to 720° C., a 1 hour anneal at 720° C., and a 2° C./min ramp to 35° C. The temporary organic binder, Standex230, of the precursor abrasive agglomerates was burned off during the vitrifying step.

After vitrifying, the abrasive agglomerate/PWA-3 powder mixture was sieved through a 106 micrometer mesh screen. The screened abrasive agglomerates were examined using a scanning electron microscope. The abrasive agglomerates were observed via optical microscopy to range in size from about 20 micrometer to about 80 micrometer, with an average size of about 50 micrometer. The agglomerate abrasive grains were predominantly spherical in shape.

The abrasive agglomerate/PWA-3 powder mixture was washed with de-ionized water to remove PWA-3 particles attached to the agglomerate surface and loose PWA-3 particles, using the following procedure. About 200 g of post sieved agglomerates/PWA-3 powder mixture was placed in a stainless container with about 2,000 ml of de-ionized water. The container was placed in an ultrasonic bath (Model 8852 from Cole-Palmer Instrument Co., Chicago, Ill.) set at a frequency of 47 kHz and the slurry was mixed using a conventional mixer for 5 min. After mixing, the container was removed from the bath and allowed to sit, undisturbed, for 5 minutes. During this time, the abrasive agglomerates settled to the bottom of the container, while the majority of the PWA-3 particles remained suspended in the liquid. The liquid was carefully decanted to remove the PWA-3 particles that were suspended in the water. The washing process was repeated at least 3 additional times. After the process, the container with abrasive agglomerates was placed in an oven at 120° C. for 3 hours to vaporize the water and dry the abrasive agglomerates, producing SDA-1.

Conglomerate abrasive particles, having as the abrasive particle SDA-1, were prepared as follows. Standex230, 36.4 parts by weight, was dissolved in 63.6 parts by weight de-ionized water by stirring using an air mixer with a Cowles blade. In a separate container, 61.5 g of the Standex230 solution, 55.40 g of milled GF and 83.1 g of SDA-1 was thoroughly mixed with a standard propeller blade for five minutes followed by agitation in an ultrasonic bath for 30 minutes, forming a slurry. The GF had been milled prior to use to a median particle size of about 2.5 micrometers. The slurry was coated into a sheet of textured polypropylene tooling, the texture being an array of cavities, and the excess slurry was removed by a doctor blade. The cavities of the polypropylene tool were truncated, square pyramids having a depth of 180 micrometers, a base with dimensions of 250 by 250 micrometers, and a distal end with dimensions of 150 by 150 micrometers. The cavities were in a square grid array with a pitch, i.e. center to center distance between cavities, of 375 micrometers. The lateral sides forming the cavities were tapered with diminishing width toward the distal end so that the conglomerate abrasive particles were easily removed from the tooling. The textured polypropylene tooling was formed by an embossing process, wherein the texture from a metal master tool, having the inverse texture of the desired polypropylene sheet, was formed into the polypropylene. The pyramidal array of the master tool was made by a conventional diamond turning process of a metal. Embossing of the polypropylene sheet via the master tool was conducted near the melting temperature of the polypropylene following conventional embossing techniques.

While in the cavities of the tooling, the slurry was dried for one hour at room temperature, followed by additional drying in an oven at 75° C. for one hour. The dried, precursor (i.e., pre-fired) conglomerate abrasive particles were removed from the tooling by using an ultrasonically driven bar (Model 902R from Branson Ultrasonic Instruments, Danbury, Conn.).

The dried precursor conglomerate abrasive particles were vitrified by mixing with 7% by weight of Hy-AlOx, based on the weight of the precursor conglomerate abrasive particles; placing the conglomerate abrasive particles/Hy-AlOx powder mixture in a refractor sager (available from Ipsen Ceramics of Ipsen Inc., Pecatonica, Ill.) and heating in a furnace in air, forming conglomerate abrasive particles. The heating schedule for the vitrifying process was as follows: a 2° C./min temperature ramp to 400° C., a 2 hour anneal at 400° C., a 2° C./min temperature ramp to 750° C., a 1 hour anneal at 750° C., and a 2° C./min ramp to room temperature. The temporary organic binder, Standex230, of the precursor abrasive agglomerates was burned off during the vitrifying step. After the firing process, the agglomerate abrasive grains were sieved through a 150 and 250 micrometer mesh screens to remove agglomerates with a size of 250 micron and larger and to remove the Hy-AlOx particles which have a particle size under 150 microns, producing the conglomerate abrasive particles, Conglomerate 1.

A structured abrasive pad was prepared using the conglomerate abrasive particles, Conglomerate 1, by the following procedure. SR368D, 28.0 g; OX50, 1.0 g; IRG819, 0.3 g; VAZO 52, 0.3 g; SP32000, 1.2 g; A174, 0.7 g; W400 57.6 g; and 10.9 g of the conglomerate abrasive particles of Example 1 were mixed together to provide a resin based slurry. The resin based slurry was coated into a sheet of textured polypropylene tooling, the texture being an array of cavities. The cavities of the polypropylene tool were rectangular cube shaped having a depth of 800 micrometer, 2.36 mm×2.36 mm at the bottom of the cavities, and 2.8 mm×2.8 mm as the cavity openings. The cavities were in a square grid array with a pitch (i.e., center to center distance between cavities) of 4.0 mm. The textured propylene tooling was prepared by an embossing process, similar to that described for Example 1. The coating width of the resin based slurry was 10 inches (25.4 cm). A sheet of 5 mil (0.127 mm) thick polyester film backing was hand laminated to the resin based slurry coating, using a rubber roll applied over the polyester film backing, such that, the slurry wetted the surface of the polyester film backing. The resin based slurry coating was then cured through the backing by passing the coating, tooling and backing under two ultraviolet lamps, medium pressure mercury bulbs that generated 400 Watts/inch (157.5 Watts/cm), available from American Ultra Company, Lebanon, Ind., at a speed of about 30 feet/minute (9.1 meters/minute). The cured slurry, which was adhered to the polyester film backing, was removed from the tooling, leaving the cube shaped features attached to the backing. The backing with features was further post cured in a conventional air through oven at 90° C. for 12 hours, forming a structured abrasive pad, Pad-1.

### Example 1

An aqueous solution was prepared containing 2.5 parts by weight (pbw) PolyOx, 1.0 pbw PWA-5 and 96.5 pbw of NaB Soln. The solution was thoroughly mixed before use as a polishing lubricant.

### Comparative Example 2 (CE-2)

An aqueous solution was prepared containing 2.5 pbw PolyOx, 1.0 pbw PWA-5 and 96.5 pbw of de-ionized water. The solution was thoroughly mixed before use as a polishing lubricant.

### Example 3

An aqueous solution was prepared containing 5.0 pbw CH543HT, 1.0 pbw PWA-5 and 94.0 pbw of NaB Soln. The solution was thoroughly mixed before use as a polishing lubricant.

Comparative Example 4 (CE-4)

An aqueous solution was prepared containing 5.0 pbw CH543HT, 1.0 pbw PWA-5 and 94.0 pbw of de-ionized water. The solution was thoroughly mixed before use as a polishing lubricant.

Using Polishing Test 1, sapphire wafers were polished using the lubricants of Examples 1 and Comparative Examples 2 and 4. Removal rate and surface finish data were determined, as previously described, Tables 1a and 1b.

TABLE 1a
Removal rate and surface finish of lubricants @3 psi polishing pressure

| | Removal Rate | | | | | |
|---|---|---|---|---|---|---|
| | (microns/minute) @ | | | Surface Finish, Ra (microns) | | |
| | 3 psi polishing pressure | | | @ 3 psi polishing pressure | | |
| | Wafer Type | | | Wafer Type | | |
| Example | A-Plane | C-Plane | R-Plane | A-Plane | C-Plane | R-Plane |
| 1 | 0.40 | 0.16 | 0.04 | 0.064 | 0.054 | 0.024 |
| CE-2 | 0.09 | 0.06 | 0.03 | 0.051 | 0.047 | 0.028 |
| 3 | * | * | * | * | * | * |
| CE-4 | 0.08 | 0.13 | 0.06 | 0.053 | 0.057 | 0.047 |

* Addition of sodium borate caused the solution to be unable to suspend the PWA-5.

TABLE 1b
Removal rate and surface finish of lubricants @6 psi polishing pressure

| | Removal Rate | | | | | |
|---|---|---|---|---|---|---|
| | (microns/minute) @ | | | Surface Finish, Ra (microns) | | |
| | 6 psi polishing pressure | | | @ 6 psi polishing pressure | | |
| | Wafer Type | | | Wafer Type | | |
| Example | A-Plane | C-Plane | R-Plane | A-Plane | C-Plane | R-Plane |
| 1 | 0.35 | 0.29 | 0.06 | 0.050 | 0.054 | 0.026 |
| CE-2 | 0.12 | 0.07 | 0.04 | 0.045 | 0.041 | 0.029 |
| 3 | * | * | * | * | * | * |
| CE-4 | 0.11 | 0.24 | 0.12 | 0.047 | 0.053 | 0.026 |

* Addition of sodium borate caused the lubricant to be unable to suspend the PWA-5.

Comparing Example 1 and Comparative Example 2 at both 3 psi and 6 psi polishing pressures, addition of the sodium borate to the lubricant provided a large increase in the sapphire removal rate, up to a factor of four higher for some sapphire wafer types, while the surface finish, generally, increased only slightly.

### Example 5

An aqueous solution was prepared containing 1.35 pbw PolyOx, 3.73 pbw PWA-5, 4.73 pbw CH543HT, 0.32 pbw NaOH-2M and 89.88 pbw of de-ionized water. The solution was thoroughly mixed before use as a polishing lubricant. The pH of the solution was 10.5. The solution viscosity was in the range of 400-800 cps.

### Comparative Example 6 (CE-6)

An aqueous solution was prepared containing 1.34 pbw PolyOx, 3.74 pbw PWA-5, 4.75 pbw CH543HT and 90.16 pbw of de-ionized water. The solution was thoroughly mixed before use as a polishing lubricant. The pH of the solution was between 8-9. The solution viscosity was in the range of 400-800 cps.

### Comparative Example 7 (CE-7)

An aqueous solution was prepared containing 3.74 pbw PWA-5, 4.81 pbw CH543HT and 91.45 pbw of de-ionized water. The solution was thoroughly mixed before use as a polishing lubricant. The pH of the solution was between 8-9. The solution viscosity was in the range of 400-800 cps.

Using Polishing Test 2, sapphire wafers were polished using the lubricants of Examples 5 and Comparative Examples 6 and 7. Removal rate and surface finish data were determined, as previously described, in Table 2.

TABLE 2

| | | Pad Wear | | | | |
|---|---|---|---|---|---|---|
| | Removal Rate | Rate | Ra | Rz | Rmax | |
| Example | (microns/min) | (microns/min) | (microns) | (microns) | (microns) | G-Ratio |
| Example 5 | 5.62 | 0.78 | 0.103 | 1.333 | 1.703 | 3.59 |
| CE-6 | 3.12 | 0.90 | 0.09 | 1.18 | 1.52 | 1.73 |
| CE-7 | 1.29 | 0.43 | 0.09 | 1.24 | 1.57 | 1.49 |

Addition of NaOH and PolyOx to the polishing solution, Example 5, led to an increase in the sapphire removal rate, about 4 times higher, compared to CE-7, while the surface roughness increased slightly. The G-ratio surprisingly improved by over a factor of 2. Little improvement in the G-ratio is observed when only PolyOx is added to the polishing solution, CE-6 vs. CE-7.

1. A polishing solution comprising:
a fluid component comprising:
water;
a basic pH adjusting agent; and
a polymeric thickening agent, wherein the polymeric thickening agent is present in the fluid component at greater than 0.01 weight percent based on the total weight of the polishing solution; and
a plurality of conditioning particles dispersed in the fluid component.

2. The polishing solution of claim 1, wherein the pH of the polishing solution is between 8 and 12.

3. The polishing solution according to claim 1, wherein the basic pH adjusting agent is present in the fluid component at between 0.1 and 10 weight percent based on the total weight of the polishing solution.

4. The polishing solution according to claim 1, wherein the basic pH adjusting agent comprises a salt of boric acid or a metal hydroxide.

5. The polishing solution according to claim 1, wherein the basic pH adjusting agent comprises sodium borate, or a derivative thereof.

6. The polishing solution according to claim 1, wherein the polymeric thickening agent is present in the fluid component at between 0.01 and 25 weight percent based on the total weight of the polishing solution.

7. The polishing solution according to claim 1, wherein the polymeric thickening agent comprises a water soluble polymeric thickening agent.

8. The polishing solution according to claim 1, wherein the polymeric thickening agent comprises polyethylene oxide.

9. The polishing solution according to claim 1, wherein the conditioning particles comprise particles having a Mohs hardness value of greater than 7.

10. The polishing solution according to claim 1, wherein the conditioning particles are present in the fluid component at between 0.5 and 5 weight percent based on the total weight of the polishing solution.

11. The polishing solution according to claim 1, wherein the conditioning particles comprise alumina.

12. A method of polishing a substrate, the method comprising:
providing a polishing pad;
providing a substrate having a major surface to be polished; and
contacting said surface with the polishing pad and the polishing solution of claim 1 while there is relative motion between the polishing pad and the substrate.

13. The method of polishing a substrate according to claim 12, wherein the substrate comprise sapphire.

14. The method of polishing a substrate according to claim 12, wherein the step of providing a substrate having a major surface to be polished further comprises providing an A-plane sapphire surface to be polished.

15. The method of polishing a substrate according to claim 12, wherein the polishing pad is a fixed abrasive polishing pad.

16. The method of polishing a substrate according to claim 12, wherein the polishing pad comprises a working surface comprising a plurality of precisely shaped abrasive composites, the precisely shaped abrasive composite comprising a resin phase and an abrasive phase.

17. A polishing system comprising a polishing pad and a polishing solution according to claim 1.
